(19) United States
(12) Patent Application Publication
(10) Pub. No.: US 2018/0172140 A1
(43) Pub. Date: Jun. 21, 2018

(54) VEHICLE SHIFT LEVER ASSEMBLY

(71) Applicant: Dura Operating, LLC, Auburn Hills, MI (US)

(72) Inventors: Michael K. Liubakka, Northville, MI (US); Bertrand Mirault, St Jean de Cornies (FR); Francis Delavigne, Ollainville (FR)

(21) Appl. No.: 15/735,991

(22) PCT Filed: Jun. 29, 2016
(86) PCT No.: PCT/US2016/039965

§ 371 Date: Dec. 13, 2017

Related U.S. Application Data
(60) Provisional application No. 62/186,794, filed on Jun. 30, 2015.

(51) Int. Cl. F16H 59/02; F16H 59/04; F16H 59/10; F16H 61/18; F16H 61/24

(52) U.S. Cl. CPC F16H 59/0204; F16H 59/044; F16H 59/105; F16H 2061/242; F16H 61/24; F16H 2059/0239; F16H 2059/0295; F16H 61/18

(57) ABSTRACT

In at least some implementations, a shift lever assembly enables shifting among gears of a vehicle transmission. A primary shift path includes multiple positions corresponding to automatic transmission shifting among multiple drive gears, a reverse gear and a park gear. A secondary shift path includes multiple positions to permit user selection among the multiple drive gears, and an interconnecting path extends between the primary shift path and the secondary shift path so that the shift lever may move between the shift paths. A blocking member is movable relative to the shift lever to selectively permit or prevent the shift lever from moving from the primary shift path to the secondary shift path. An actuator moves the blocking member to prevent shift lever movement to the secondary shift path unless the shift lever is in a position corresponding to one of the multiple drive gears.

### REFERENCE TO CO-PENDING APPLICATIONS

This application claims the benefit of U.S. Provisional Patent Application Ser. No. 62/186,794 filed Jun. 30, 2015, which is incorporated herein by reference in its entirety.

### TECHNICAL FIELD

The present disclosure relates to a vehicle shift lever system.

### BACKGROUND

In some vehicles, a gear shift lever in a passenger compartment of the vehicle can be moved by an operator of the vehicle to shift the vehicle transmission between its park gear and other gears, such as reverse, neutral and forward drive gears. The shift lever is mechanically coupled to the transmission through a cable that transmits the shift lever movement to a transmission shift mechanism.

Other vehicles use a so-called “shift-by-wire” system wherein an operator shift lever or shift control unit is not physically coupled to the transmission shift mechanism by a cable. Instead, the shift control unit is electrically coupled to a shift actuator that is arranged to shift the transmission upon receipt of a signal from the shift control unit that a transmission gear shift is desired by the operator. In these systems, the position of the shift lever does not necessarily correspond to the currently selected transmission gear.

### SUMMARY

In at least some implementations, a shift lever assembly for shifting among gears of a vehicle transmission includes a shift lever, a blocking member and an actuator that moves the blocking member relative to the shift lever. The shift lever is rotatable about a pivot among multiple positions corresponding to vehicle transmission gears. The shift lever includes or is associated with a second pivot having a second axis that is perpendicular to the first axis so that the shift lever may pivot about the second axis. A primary shift path includes multiple positions corresponding to automatic transmission shifting among multiple drive gears, a reverse gear and a park gear. A secondary shift path includes multiple positions to permit user selection among the multiple drive gears, and an interconnecting path extends between the primary shift path and the secondary shift path. The shift lever may move between the primary shift path and the secondary shift path in the interconnecting path. The blocking member has a first position that prevents the shift lever from moving from the primary shift path into the interconnecting path and a second position permitting the shift lever to move from the primary shift path into the interconnecting path. The actuator moves the blocking member to the second position when the shift lever is in a position corresponding to one of said multiple drive gears.

A shift lever assembly for shifting among gears of a vehicle transmission that includes an automatic mode in which a vehicle controller shifts the transmission among multiple forward drive gears and a manual mode in which a user may shift the transmission among the multiple forward drive gears. The assembly includes a primary shift path having a home position and multiple positions spaced from the home position, where the positions correspond to automatic transmission shifting among multiple drive gears, a reverse gear and a park gear. The assembly also includes a secondary shift path including multiple positions to permit user selection among the multiple forward drive gears, the secondary shift path being offset from the primary shift path in a direction corresponding to pivoted motion of the shift lever about the second axis. The shift lever is coupled to a first pivot for movement about a first axis so that the shift lever may be moved among the positions in either the primary shift path or the secondary shift path to cause a transmission gear change, and the shift lever is coupled to a second pivot for movement about a second axis so that the shift lever may be moved between the primary shift path and the secondary shift path. A blocking member has a first position that prevents the shift lever from moving from the primary shift path to the secondary shift path and a second position permitting the shift lever to move from the primary shift path to the secondary shift path. And an actuator moves the blocking member to the second position when the shift lever is in a position corresponding to one of said multiple drive gears, and to the first position when the shift lever is not in a drive gear (e.g. is in park, neutral or reverse).

In at least some implementations, the shift lever may be biased to the home position so that the shift lever is in the home position absent a force being applied to the shift lever to cause a transmission shift. In applications where the interconnecting path is aligned with the home position, it is desirable to prevent the shift lever from being moved to the secondary shift path when the vehicle is not in a forward drive gear (such as park, reverse or neutral). In the implementation noted above, this is done via control of an actuator that moves a blocking member relative to the shift lever to selectively prevent movement of the shift lever to the secondary shift path when the shift lever is not in a forward drive gear.

A return member may also be provided to automatically move the shift lever from the secondary shift path to the primary shift path in certain circumstances. The return member may include a cam mounted on a shaft on which the blocking member is also mounted. The cam may engage a lever and cause the lever to engage and move the shift lever from the secondary shift path to the primary shift path. With the cam mounted on the same shaft as the blocking member, both of these components may be driven by the same actuator. In one form, the actuator drives a gear that meshes with and drives a gear on the shaft to rotate the shaft and move the blocking member and return member cam in a desired manner.

Other embodiments can be derived from combinations of the above and those from the embodiments shown in the drawings and the descriptions that follow. Further, within the scope of this application it is envisaged that the various aspects, embodiments, examples, features and alternatives set forth in the preceding paragraphs, in the claims and/or in the following description and drawings may be taken independently or in any combination thereof. For example, features disclosed in connection with one embodiment are applicable to all embodiments, except where there is incompatibility of features.

### BRIEF DESCRIPTION OF THE DRAWINGS

The following detailed description of preferred implementations and best mode will be set forth with regard to the accompanying drawings, in which:

FIG. 1 is a perspective view of a shift lever assembly;

FIG. 2 is a partially exploded perspective view of the shift lever assembly;

FIG. 3 is a fragmentary perspective view of the shift lever assembly with a housing removed to show internal components including a return member having a cam and a return lever;

FIG. 4 is another fragmentary perspective view of the shift lever assembly from a different angle than FIG. 3;

FIG. 5 is an enlarged fragmentary perspective view of the shift lever assembly showing a blocking member in a first position;

FIG. 6 is an enlarged fragmentary perspective view of the shift lever assembly in the position of FIG. 5 and showing the return lever position;

FIG. 7 is a perspective view of a blocking member, cam and driven gear on a shaft for actuating the blocking member and return member;

FIG. 8 is an enlarged fragmentary perspective view of the shift lever assembly showing the blocking member in a second position;

FIG. 9 is an enlarged fragmentary perspective view of the shift lever assembly in the position of FIG. 8 and showing the return lever position;

FIG. 10 is an enlarged fragmentary perspective view of the shift lever assembly in the position of FIG. 8 and showing the shift lever pivoted about a second axis and into a position in which an end of the shift lever is in a secondary shift path;

FIG. 11 is a fragmentary perspective view showing an actuator, the shaft, return cam and return lever in a first position relative to the shift lever;

FIG. 12 is a fragmentary perspective view showing an actuator, the shaft, return cam and return lever in a second position relative to the shift lever to move the shift lever from the secondary shift path to a primary shift path;

FIG. 13 is fragmentary perspective view showing a circuit board and rotary position sensors for the shift lever and for the shaft that carries the blocking member and cam; and

FIG. 14 is a schematic top view of a portion of the housing and showing the primary shift path, the secondary shift path and an interconnecting path, as well as various shift lever positions denoted in broken lines.

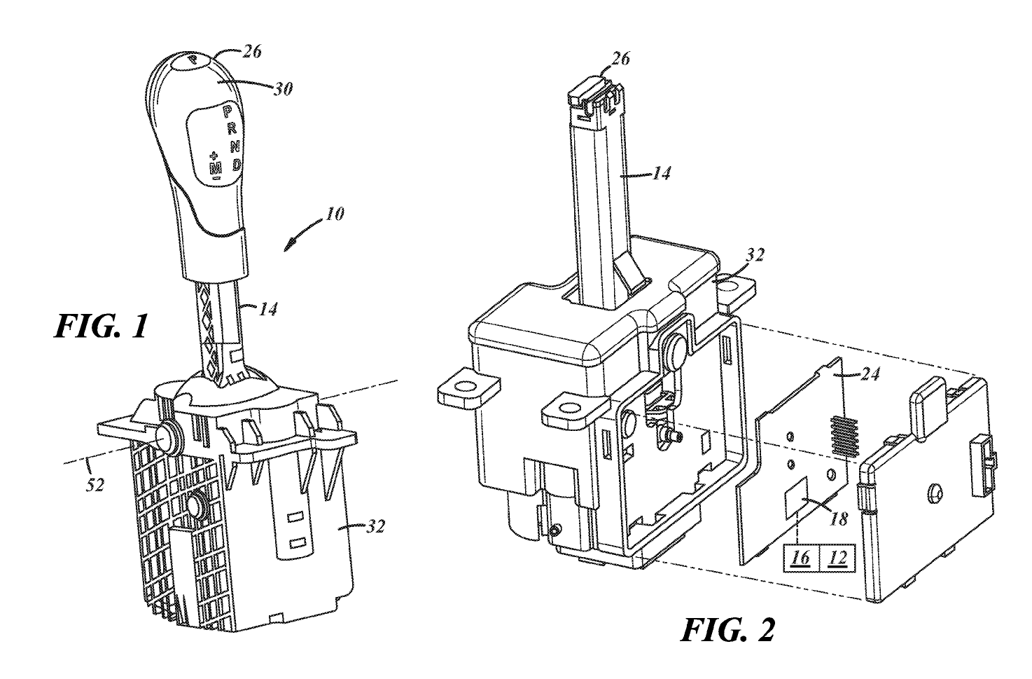

### DETAILED DESCRIPTION

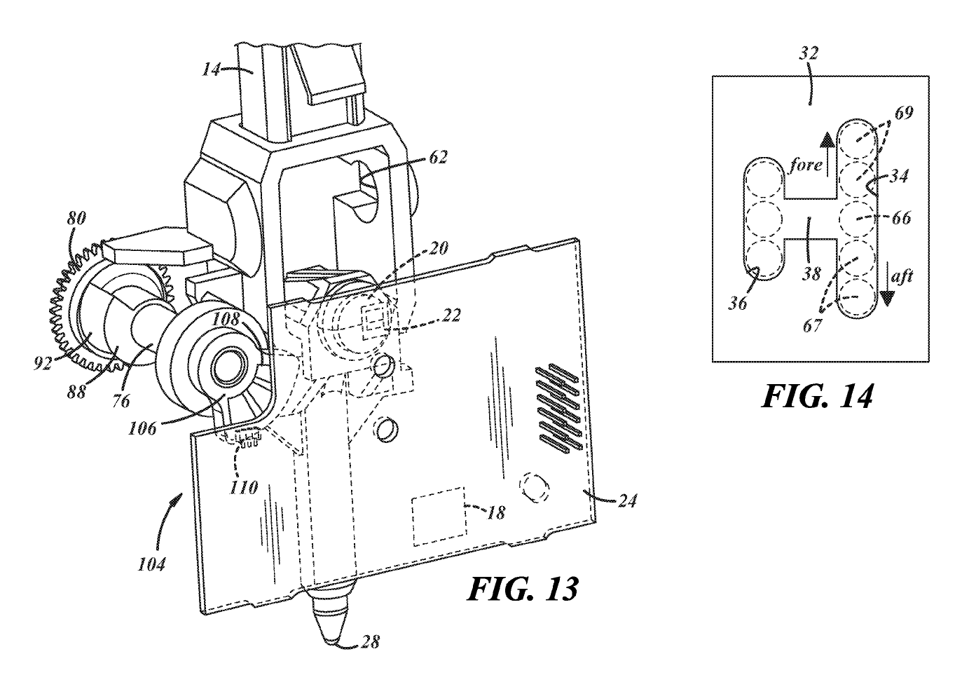

The accompanying drawings illustrate various attributes of at least some implementations of a vehicle shift lever assembly 10 that may be used to change a mode of a vehicle transmission 12 (e.g. cause a transmission gear change). The assembly includes a gear shift lever 14 that may be moved by a driver of the vehicle to shift the transmission 12 among various modes, typically including park, neutral, reverse and forward drive gears. The shifting system of which the shift lever assembly 10 is a part may be a so-called “shift by wire” system where an operator command for a gear shift is electrically transmitted to a transmission shift actuator 16 that is coupled to a shift mechanism of the transmission 12 to cause the actuator to shift the transmission. There can be many different ways to generate an electrical signal to monitor/detect lever position and send the signal to the electronic control unit (ECU) 18 to actuate the shift actuator 16 to a desired drive mode or gear. As an example shown in FIG. 13, a magnet 20 may be attached to the shift lever 14, and a sensor 22 (e.g. an angular hall effect sensor) may be mounted on a printed circuit board (PCB) 24 with an ECU, and as the shift lever 14 rotates or tilts the sensor 22 measures the magnetic flux densities of two axis and calculates the angle of the shift lever and determines the drive mode that the driver selected. Of course, other arrangements may be implemented.

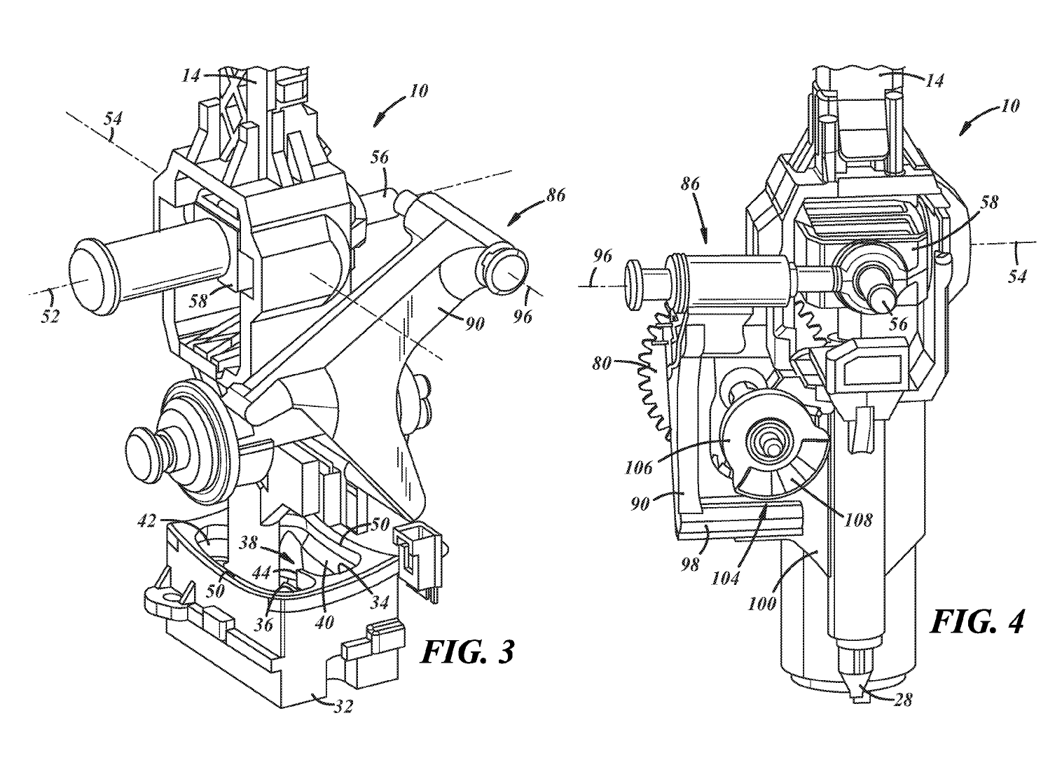

In at least some implementations, the vehicle shift lever assembly 10 may include the shift lever 14 pivoted between its ends 26, 28 for pivoted movement between multiple positions to permit a transmission shift. One end 26 of the shift lever 14 may include or be connected to a knob 30 adapted to be engaged by a user's hand and facilitate manual movement of the shift lever. The other end of the shift lever 14 may be moved relative to a housing 32 of the assembly 10, and the housing 32 may be arranged to define the various positions of the shift lever 14. In at least some implementations, such as is shown in FIG. 3, the housing 32 may include a primary shift path 34 having positions of the shift lever that correspond to park, neutral, reverse and drive gears of the transmission 12 where the drive gears may be automatically selected and shifted among by a vehicle controller as is common with automatic transmissions. The assembly 10 may also include a secondary shift path 36 in which the transmission 12 may be manually shifted among, for example, among various drive gears (e.g. first, second, third, etc). For example, the shift lever 14 may be pivoted or tipped in a first direction to cause an upshift from a lower gear to a higher gear and the shift lever may be pivoted or tipped in a second direction to cause a downshift from a higher gear to a lower gear. The secondary shift path 36 may be offset from the primary shift path 34 and connected thereto by an interconnecting path 38.

In the example shown, the housing 32 includes a first cavity 40 that defines the primary shift path 34, a second cavity 42 that defines the secondary shift path 36, and an opening, slot or passage 44 between the first and second cavities 40, 42 that defines the interconnecting path 38. The cavities 40, 42 may be defined by side walls and a bottom wall, and may be open at their upper sides 50 to receive therein the end 28 of the shift lever 14, or a component associated with the shift lever. The bottom walls and/or side walls may include detents or other shift feel features arranged to provide tactile feedback to a person moving the shift lever 14 as the shift lever moves from one position to the next to cause a transmission shift. For example, the bottom walls may include an upwardly raised portion (e.g. ramps) between adjacent positions or stations, and the end 28 of the shift lever 14 received against the bottom walls may need to slide up and over the raised portions to move out of one station and into the next. Hence, the effort required to move the shift lever may vary during movement of the shift lever 14 and this may be noticeable to a person moving the shift lever.

In at least some implementations, the primary shift path 34 and the secondary shift path 36 are generally parallel and laterally offset or spaced apart. In the example shown, the primary shift path 34 and the secondary shift path 36 extend in a fore-aft direction of the vehicle (where a major dimension and the movement of the shift lever in either path is generally toward the front and rear of the vehicle), and the interconnecting path 38 extends in a cross-car direction (toward the sides of the vehicle). Of course, the paths could be otherwise arranged.

To accommodate the fore-aft pivoting movement of the shift lever 14, the shift lever pivots about a first axis 52 that extends in a first direction which is the cross-car direction in the illustrated embodiment. To accommodate the cross-car movement of the shift lever 14 in the interconnecting path 38 as the shift lever is moved between the primary and secondary shift paths 34, 36, the shift lever pivots about a second axis 54 that extends in a second direction, which is the fore-aft direction in the illustrated embodiment. In one implementation, the shift lever 14 is coupled to a pivot pin 56 that is carried by a pivot body 58. The pivot pin 56 may extend through a passage in the pivot body 58 so that opposed ends of the pin extend outwardly from opposed sides of the body and the body may rotate about or pivot relative to the pin. The pivot body 58 is coupled to the shift lever 14 so that the shift lever may pivot relative to the pivot body in the cross-car direction. In the example shown, the pivot body 58 includes two outwardly extending bosses or tabs 60, each extending outwardly from opposed sides of the pivot body and oriented at right angles to the pivot pin 56. The tabs 60 are received in pockets 62 or openings in the shift lever 14 that extend or face in the cross-car direction so that the shift lever 14 can pivot about the tabs 60 relative to the pivot body 58 in the cross-car direction. The tabs 60 couple the pivot body 58 to the shift lever 14 so that the shift lever and the pivot body pivot about the pin 56 when the shift lever is moved in the fore-aft direction.

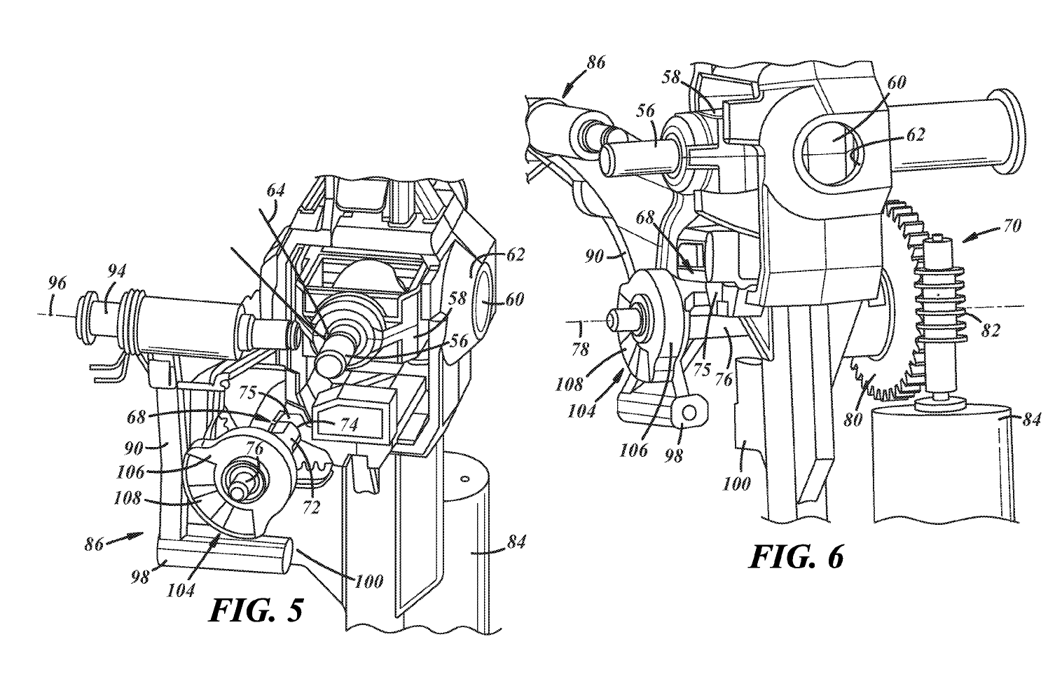

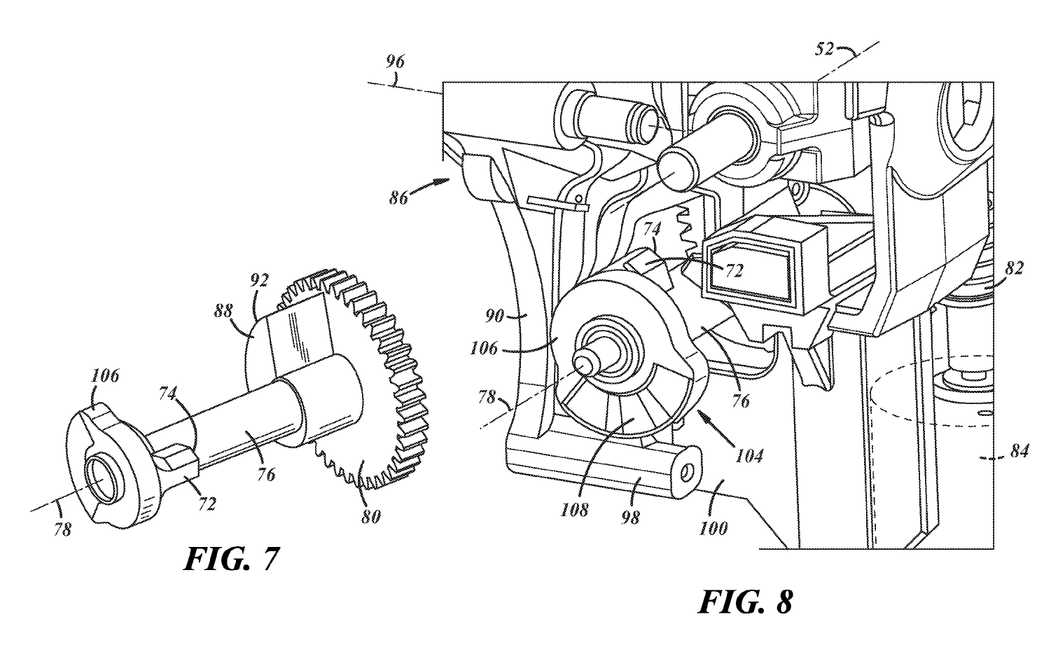

In either or both of the primary shift path 34 and secondary shift path 36, the shift lever 14 may include a biasing member 64 (shown diagrammatically as a spring wrapped around pivot pin 56 in FIG. 5, with ends engaged with the housing 32 or another structure) that yieldably biases the shift lever 14 to an intermediate or home position 66 (FIG. 14). From this home position 66, the shift lever 14 may be moved fore and aft (upwardly and downwardly as viewed in FIG. 14) to shift among various transmission gears, but in the absence of a force moving the shift lever to cause a transmission shift, the shift lever will return to the home position 66 under the force of the biasing member 64. In the primary shift path 34, the shifting may occur in either direction (e.g. fore and aft) among park, reverse, neutral and drive. When in the drive gear, the transmission 12 automatically is shifted among various drive gears (e.g. first through sixth) by a vehicle controller, as is known in the art. Accordingly, if the vehicle is in park, the shift lever 14 will be in the home position 66 and the shift lever may be pivoted in one direction to one or more shift positions 67 (e.g. aft, or downwardly as viewed in FIG. 14) to shift the transmission 12 to either reverse, neutral or drive. If desired, shifting in the other direction may be prevented because there is no gear to shift to in that direction relative to park, and this may be done by a mechanism that is not part of this disclosure. When the vehicle is in drive, the shift lever 14 may be moved in the opposite direction to one or more shift positions 69 (e.g. fore, or upwardly as viewed in FIG. 14) to either neutral, reverse or park (shifting beyond drive may be prevented or ignored by the system in applications where there is no position beyond drive). After such shifting has occurred, the shift lever 14 will return to the home position 66 under the force of the biasing member 64 (e.g. a spring acting on the lever and rotating it about the first pivot axis 52).

In at least some implementations, the interconnecting path 38 is aligned with and/or communicated with the home position 66 of the primary shift path 34. Accordingly, when the shift lever 14 is in the home position 66 of the primary shift path 34, cross-car pivoting of the shift lever about the second axis 54 moves the shift lever through the interconnecting path 38 to the secondary shift path 36. Because the secondary shift path 36 is only useful to shift among various drive gears (and not park, reverse or neutral), a blocking member 68 may be provided to inhibit or prevent movement of the shift lever 14 to the secondary shift path 36 when the vehicle is not in a drive gear.

In at least some implementations, the blocking member 68 is driven by an actuator 70 to selectively prevent movement of the shift lever 14 out of the primary shift path 34 (e.g. in the cross-car direction into the interconnecting path 38). In at least some implementations, the blocking member 68 engages the shift lever 14 or a component that moves with the shift lever (e.g. at a first engagement surface) to prevent movement of the shift lever from the primary shift path 34 to the secondary shift path 36 unless the vehicle is in a drive gear (i.e. not park, neutral or reverse). As noted above, the shift lever 14 movement and hence, its position, is determined by the rotary position sensor 22 and communicated with a controller 18. The controller 18 may be coupled to or otherwise communicated with the blocking member 68 to control the position of the blocking member in accordance with the gear in which the vehicle is currently being operated.

The blocking member 68 in the implementation shown includes a finger 72 with a stop surface 74 facing in the first or cross-car direction. The shift lever 14 and the stop surface 74 are constructed and arranged so that the stop surface is engaged by an engagement surface 75 or other portion of the shift lever if the shift lever is pivoted about the second pivot axis 54 when the vehicle is not in a drive gear as determined by the controller. When the shift lever 14 is pivoted about the first axis 52 to shift the transmission to the drive position in the primary shift path 34, the finger 72 is moved so that the stop surface 74 is not aligned with the shift lever 14 and the shift lever may be pivoted about the second axis 54 to the secondary shift path 36.

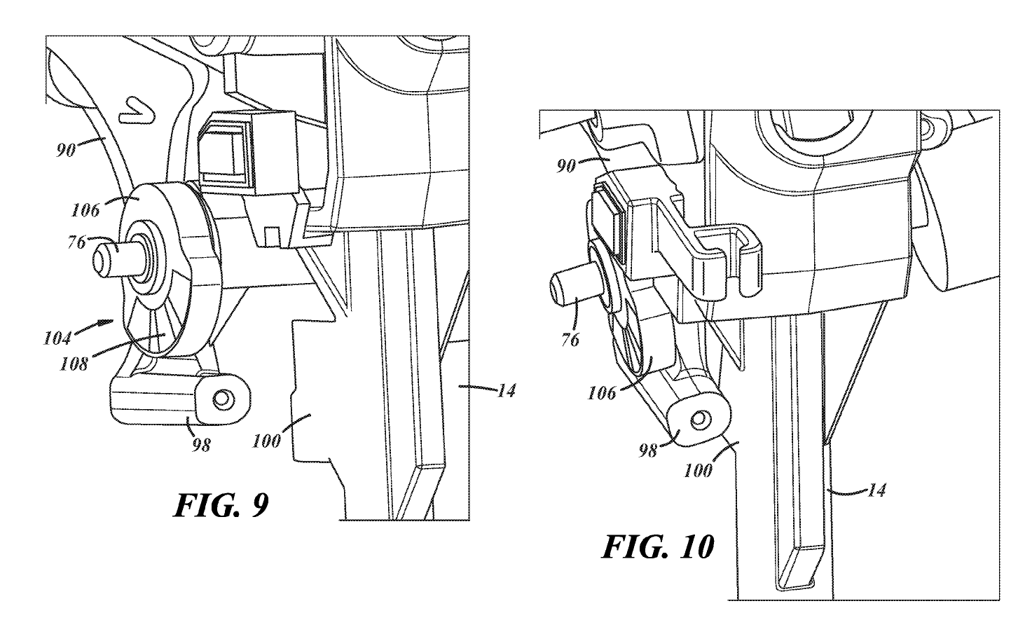

To control the movement of the blocking finger 72 relative to the shift lever 14, the blocking finger may be carried on and extend radially outwardly from a shaft 76 that is movable relative to the shift lever to selectively align the blocking finger with a first engagement surface 75 on the shift lever. In the example shown, the shaft 76 is rotatable relative to the shift lever 14 about a third axis 78 parallel to the first axis 52, although other arrangements may be used, as desired. The shaft 76 may be coupled to the actuator 70 that rotates the shaft. The actuator 70 may be coupled to the controller that senses the shift lever movement and current transmission gear, or a different controller. Hence, as shown in FIGS. 5 and 6, the actuator 70 may rotate the shaft 76 and finger 72 into a first position in which the stop surface 74 is aligned with the first engagement surface 75 of the shift lever 14 to prevent movement of the shift lever to the secondary shift path 36 whenever it is determined that the transmission is not in a drive gear. As shown in FIGS. 8 and 9, when the controller determines that the shift lever 14 has been moved within the primary shift path 34 to shift the transmission into drive, the actuator 70 may be commanded to rotate the shaft 76 to a second position in which the stop surface 74 is removed from the cross-car path of the shift lever 14. To facilitate rotation of the shaft 76, the shaft may include a gear 80 fixed to the shaft for rotation with the shaft. The gear 80 may be driven by the actuator 70, which may include a worm gear 82 driven by a motor 84. Of course, other arrangements may be utilized. When it is determined that the transmission 12 has been shifted out of drive, the actuator 70 rotates the shaft 76 to return the finger 72 to its first or blocking position to prevent movement of the shift lever 14 out of the primary shift path 34.

The shift lever assembly 10 may also include a shift lever return member 86 that selectively moves the shift lever 14 out of the secondary shift path 36, and may, in at least some implementations, move the shift lever to the primary shift path 34. The return member 86 may include a drive member 88 and a lever 90 driven by the drive member to, in turn, move the shift lever 14 out of the secondary shift path 36 and to the primary shift path 34. This may occur in any desired situation, including but not limited to, when the vehicle is turned off, power is lost, or a parking brake is activated. In these or other situations, it may be desirable to shift the vehicle transmission 12 out of a drive gear and to neutral or park, so the shift lever 14 is driven to a corresponding position.

In at least some implementations, the drive member includes a cam 88 that is mounted to the shaft 76 and hence, rotated by the actuator 70. The cam 88 has a radially variable (e.g. inclined) cam surface 92 that may engage the lever 90 during at least a portion of the rotation of the shaft 76 to move the lever 90 about a pivot 94 that has an axis 96 that may be perpendicular to the first axis 52. The lever 90, in turn, is engageable with the shift lever 14 or a component that moves with the shift lever (e.g. at a second engagement surface) as the lever 90 is pivoted about the pivot 94 by the cam 88. In the implementation shown, the lever 90 includes an arm 98 that extends radially from the pivot 94 and is arranged to engage a flange 100 on the shift lever 14 during a portion of the rotation of the lever caused by the cam 88.

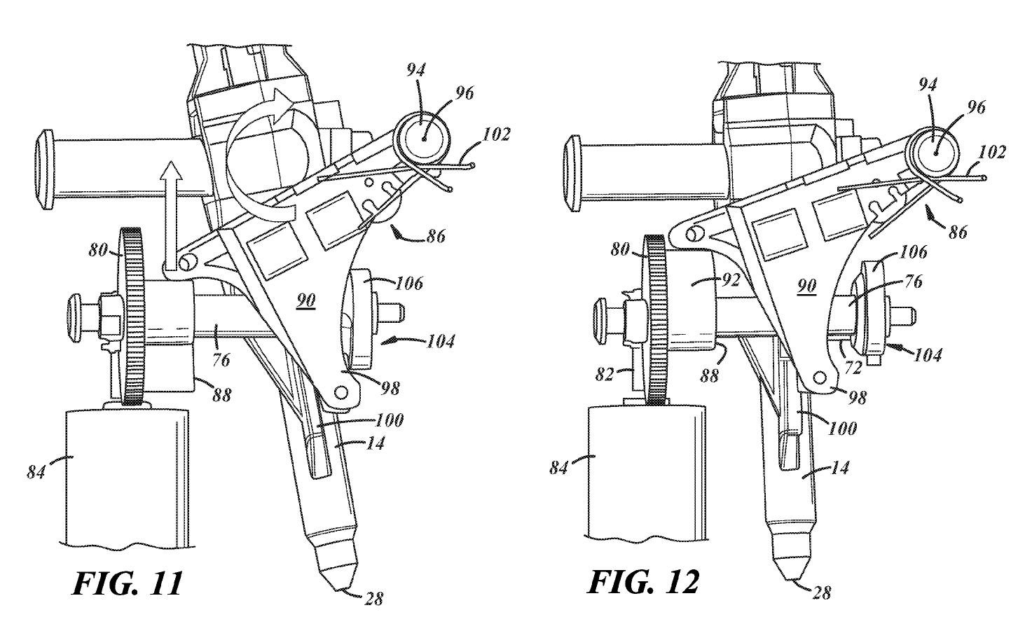

Accordingly, in a desired situation or circumstance, the actuator 70 may be driven to rotate the shaft 76 and move the cam 88 from a first position wherein cam does not cause the lever 90 to engage the shift lever 14 (see e.g. FIGS. 5, 6, 9 and 10), to a second position wherein the cam engages the lever and causes the lever to engage the shift lever and move the shift lever out of the secondary shift path 36 (see e.g. FIGS. 11 and 12). After this movement of the cam 88, the cam may be returned to or toward the first position, and the lever 90 may be rotated in the opposite direction about the pivot axis 96 by a biasing member, such as a return spring 102 that acts on the lever. Hence, when the lever 90 is rotated about the axis 96 from a first position to a second position to drive the shift lever 14 out of the secondary shift path 36, the lever is rotated against the force of the return spring 102 which provides a force on the lever tending to return to the lever toward its first position. The cam 88 and the lever 90 may then be reset for a subsequent activation, as desired. The motor 84 may be reversible so that the shaft 76 may be rotated in both directions, or the motor may rotate in one direction such that the shaft is rotated a full revolution for consecutive actuations of the lever 90 with the cam 88.

The same shaft 76 and actuator 70 (e.g. motor 84) may be used to control the position of both the blocking member 68 and the return member 86 to selectively prevent movement of the shift lever 14 to the secondary shift path 36 and to automatically move the shift lever out of the secondary shift path in a controlled manner. The blocking member 68 and the cam 88 may be spaced apart on the shaft 76 and located adjacent to opposite sides of the shift lever 14, if desired. This may prevent the cam 88 from engaging the first engagement surface 75 and the blocking member 68 from engaging the lever 90. In at least some implementations, the blocking member 68 and the cam 88 are spaced apart on the shaft 76 by a distance greater than a width of the portion of the shift lever 14 that is located between the cam 88 and blocking finger 72.

The rotary position of the blocking member 68 and the cam 88 may be sensed or monitored by a rotary position sensor 104 carried by the shaft 76 for rotation with the shaft. In the implementation shown, the shaft 76 includes a head 106 that carries one or more magnets 108 that are rotated relative to a sensor 110 on the circuit board 24 and which also may include or carry the blocking finger 72. The sensor 110 may communicate with a controller (e.g. controller 18 or another controller) to enable a determination of the rotary position of the shaft 76, and the controller may use this information to accurately drive the shaft to move the blocking member 72 and cam 88 that are coupled to the shaft. The shaft 76 may rotate about an axis 78 that is offset from but, in at least some implementations, parallel to the first axis 52. And the magnet 108 carried by the shaft 76 may be radially offset from the magnet 20 used to determine the position of the shift lever 14, as shown in FIG. 13.

Various other positions and attributes of at least some implementations of the vehicle shift lever system are shown and described in the accompanying drawings. Some of the drawings include text describing certain features of the shift lever embodiment shown in the drawings, but other arrangements and features may be used in this embodiment or other shift lever embodiments.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A shift lever assembly for shifting among gears of a vehicle transmission, comprising:
a pivot having a first axis;
a shift lever rotatable about the first axis among multiple positions corresponding to vehicle transmission gears, the shift lever including a second pivot having a second axis that is perpendicular to the first axis so that the shift lever may pivot about the second axis;
a primary shift path including multiple positions corresponding to automatic transmission shifting among multiple drive gears, a reverse gear and a park gear;
a secondary shift path including multiple positions to permit user selection among the multiple drive gears;
an interconnecting path extending in a direction parallel to the first axis between the primary shift path and the secondary shift path and in which the shift lever may move to switch between the primary shift path and the secondary shift path;
a blocking member having a first position that prevents the shift lever from moving from the primary shift path into the interconnecting path and a second position permitting the shift lever to move from the primary shift path into the interconnecting path; and
an actuator that moves the blocking member to the second position when the shift lever is in a position corresponding to one of said multiple drive gears.

2. The assembly of claim 1 wherein the actuator moves the blocking member to the first position when the shift lever is in a position corresponding to the park gear or the reverse gear.

3. The assembly of claim 1 wherein the blocking member is carried by a shaft and extends radially outwardly from the shaft, and the actuator rotates the shaft to selectively align the blocking member with an engaging surface of the shift lever with respect to movement of the shift lever about the second axis.

4. The assembly of claim 3 which also includes a driven gear on the shaft and the actuator includes a motor and a driving gear the engages and rotates the driven gear to rotate the shaft and the blocking member relative to the shift lever.

5. The assembly of claim 2 which also includes a return member driven by the actuator between a first position and a second position, and wherein the return member is engageable with the shift lever during at least a portion of the movement between the first position and second position of the return member to cause the shift lever to pivot about the second axis through the interconnecting path and from the secondary shift path to the primary shift path.

6. The assembly of claim 3 which also includes a return member carried by the shaft for rotation with the shaft, and wherein the return member is engageable with the shift lever during at least a portion of the rotation of the return member to cause the shift lever to pivot about the second axis through the interconnecting path and from the secondary shift path to the primary shift path.

7. The assembly of claim 6 wherein the return member includes a cam carried by the shaft for rotation with the shaft and having a cam surface and a lever engageable with both the cam surface and engageable with the shift lever to move the shift lever from the secondary shift path to the primary shift path in accordance with engagement of the lever by the cam.

8. The assembly of claim 7 wherein the cam surface extends radially outwardly from the shaft and the lever is rotatable about a third axis that is parallel to the first axis.

9. The assembly of claim 1 wherein the multiple positions in the secondary shift path include an upshift position, a downshift position and a home position and wherein the home position is aligned with the interconnecting path.

10. The assembly of claim 9 which also comprises a biasing member that, when the shift lever is within the secondary shift path, yieldably biases the shift lever to the home position.

11. The assembly of claim 3 which also includes a rotary position sensor associated with the shaft to enable a determination of the rotary position of the shaft and the blocking member.

12. The assembly of claim 11 which also include a rotary position sensor associated with the shift lever to enable a determination of the position of the shift lever within the primary shift path and secondary shift path and wherein the rotary position sensor associated with the shaft is radially offset from the rotary position sensor associated with the shift lever.

13. The assembly of claim 1 which includes a biasing member acting on the shift lever to move the shift lever to a home position absent another force acting on the shift lever to cause a transmission shift, wherein the home position is aligned with the interconnecting path.

14. A shift lever assembly for shifting among gears of a vehicle transmission that includes an automatic mode in which a vehicle controller shifts the transmission among multiple forward drive gears and a manual mode in which a user may shift the transmission among the multiple forward drive gears, the shift lever comprising:
a primary shift path including a home position and multiple positions spaced from the home position, where the positions correspond to automatic transmission shifting among multiple drive gears, a reverse gear and a park gear;
a secondary shift path including multiple positions to permit user selection among the multiple forward drive gears, the secondary shift path being offset from the primary shift path in a direction corresponding to pivoted motion of the shift lever about the second axis;
a shift lever coupled to a first pivot for movement about a first axis so that the shift lever may be moved among the positions in either the primary shift path or the secondary shift path to cause a transmission gear change, and the shift lever is coupled to a second pivot for movement about a second axis so that the shift lever may be moved between the primary shift path and the secondary shift path;
a blocking member having a first position that prevents the shift lever from moving from the primary shift path to the secondary shift path and a second position permitting the shift lever to move from the primary shift path to the secondary shift path; and
an actuator that moves the blocking member to the second position when the shift lever is in a position corresponding to one of said multiple drive gears.

15. The assembly of claim 14 which includes a biasing member acting on the shift lever to yieldably bias the shift lever to the home position so that the shift lever returns to the home position after being moved to cause a transmission shift.

16. The assembly of claim 15 which also includes an interconnecting path that extends between the primary shift path and the secondary shift path and in which a portion of the shift lever moves as the shift lever is moved between the primary shift path and the secondary shift path, and wherein the home position is aligned with the interconnecting path.

17. The assembly of claim 14 wherein the blocking member is carried by a shaft and extends radially outwardly from the shaft, and the actuator rotates the shaft to selectively align the blocking member with an engaging surface of the shift lever with respect to movement of the shift lever about the second axis.

18. The assembly of claim 17 which also includes a return member associated with the shaft and driven during at least a portion of the shaft rotation between a first position wherein the return member does not engage the shift lever to a second position wherein the return member engages and displaces the shift lever, the return member being engageable with the shift lever during at least a portion of the movement from the first position to the second position to cause the shift lever to pivot about the second axis from the secondary shift path to the primary shift path.

19. The assembly of claim 18 wherein the return member includes a cam carried by the shaft for rotation with the shaft, and a lever engageable with both the cam and with the shift lever to move the shift lever from the secondary shift path to the primary shift path as the lever is engaged by the cam and moved from the first position to the second position as the shaft rotates.

20. The assembly of claim 19 wherein the cam includes a cam surface that extends radially outwardly from the shaft for engagement with the lever, and the lever is rotatable about a third axis that is parallel to the first axis.
